(19) United States
(12) Patent Application Publication
(10) Pub. No.: US 2008/0307374 A1
(43) Pub. Date: Dec. 11, 2008

(54) METHOD, SYSTEM, AND COMPUTER PROGRAM PRODUCT FOR MAPPING A LOGICAL DESIGN ONTO AN INTEGRATED CIRCUIT WITH SLACK APPORTIONMENT

(75) Inventors: James C. Gregerson, Hyde Park, NY (US); Leonard M. Greenberg, Hopewell Junction, NY (US); Steven J. Hnatko, Fishkill, NY (US); Kirk D. Lamb, Kingston, NY (US); James H. McCullen, Pleasant Valley, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/758,277

(22) Filed: Jun. 5, 2007

(51) Int. Cl. G06F 9/45

(52) U.S. Cl. 716/6

(57) ABSTRACT

A logical design including multiple logical blocks is mapped onto an integrated circuit chip. A chip level floor plan is created on the chip, including temporary areas on the chip set aside for accommodating logical blocks having logical content including timing requirements based on the logical design. The temporary areas are translated into physical cells on the chip with pins assigned for inputs and outputs for the logical blocks. The logical blocks are mapped to the physical cells on the chip in a time sensitive manner using timing assertions to form temporary logical partitions. Blocks on the chip, including the temporary logical partitions, are connected based on the timing assertions. A timing analysis is performed on the chip to determine timing slack associated with each temporary logical partition. A determination is made whether the timing slack is acceptable. If the timing slack is not acceptable, the slack is apportioned for, and apportioned slack information is fed back in the form of timing assertions. Mapping, connecting, performing a timing analysis, and apportioning for slack are repeated until the timing slack associated with each temporary logical partition is determined to be acceptable.

### BACKGROUND

The present invention relates generally to circuit design and, more particularly, to mapping a logical design onto an integrated circuit.

Today, the prevailing design methodology for integrated circuits is top down design using hardware description languages (HDLs). Using a top down design method, the designer creates an integrated circuit by hierarchically defining functional components of the circuit and then decomposing each component into smaller and smaller components. Two of the primary types of components used in integrated circuits are datapaths and control logic. Control logic, typically random logic, is used to control the operations of datapaths. Datapath areas of the circuit perform functional operations, such as mathematical or other operations. More particularly, datapaths are typically composed of large numbers of highly regular and structured datapath functions, each datapath function typically including an arrangement of logic cells.

These various components of an integrated, circuit are initially defined by their functional operations and relevant inputs and outputs. The designer may also provide basic organizational information about the placement of components in the circuit using floorplanning tools. During these design stages, the designer structures the circuit using considerable hierarchical information and typically provides substantially regularity in the design through the use of datapaths and the like.

From the HDL description, the actual logic cell implementation is determined by logic synthesis, which converts the functional description of the circuit into a specific circuit implementation. The logic cells are then placed, i.e., the coordinate location of the logic cells in the circuit layout is determined, and routed, i.e., wiring between logic cells is determined.

Currently, conventional placement and routing systems accept as their input a flattened netlist resulting from the logic synthesis process. This flattened netlist identifies the specific logic cell instances from a target standard cell library and merely describes the specific cell to cell connectivity.

Unfortunately, the flattened netlist fails to capture any of the hierarchical structure or regularity that was originally provided in the datapaths by the designer. That is, the netlist resulting from logic synthesis merely describes the very lowest level of detail, the connections of logic cells. This is offhandedly known as a “sea of gates”. Thus, a conventional placement and routing system, operating only on the “sea-of-gates” netlist, cannot take advantage of any of the hierarchical or structural regularity of the datapath components that the designer originally provided in the HDL and floorplanning stages. Conventional placement and routing system thus place the individual logic cells without any regard as to their association with each other (other than connectivity) in the larger units of the datapath functions and datapath regions of the circuit. As a result; there is significant degradation in both the die-size and performance of datapaths in conventionally placed and routed designs.

In some integrated circuits, the degradation in performance of datapath regions from automatic placement and routing systems is unacceptable. This is particularly true in mainframe or other high-end microprocessors. As a result, designers of these circuits typically partition the circuit at the HDL level into its datapaths (and other sections with regular structures) and random logic areas. Only the random logic portions of the circuit are optimized by conventional logic synthesis tools and automatic placement and routing tools. The datapath regions are usually custom designed using special library cells rather than the standard cells. The “datapath core” is then placed and routed manually.

This manual process is extremely time consuming and increases the time necessary to bring the circuit to market. Time to market is an important concern in designing electronics systems, whether for consumer goods or industrial applications. In many cases, time to market is a function of how early in the design cycle the first production circuits can be manufactured and tested. This stage of “first silicon” is directly impacted by the speed with which the circuit designer can floorplan, place, and route the circuit.

Accordingly, where time to market is more important than circuit performance, as in low-end Application Specific Integrated Circuit (ASIC) designs, the designers typically use logic synthesis tools, standard cell libraries, and automatic placement and touting to optimize the entire design. While the regularity of datapath portions may be lost and performance degraded, the circuit is produced relatively quickly. Thus, performance suffers, but time to market is reduced.

Additionally, in the custom design approach, as the datapath core is usually designed with custom designed datapath cells, it is almost impossible to mix the datapath core with associated control logic. Rather, the datapath core is designed as a rather impermeable block, and its associated control logic is separately designed as a block. As a result, wiring at the chip level will have to route around the datapath, core, thereby increasing wire length and degrading chip performance. Further, because the datapath core is treated as a block, significant area, may be left over after custom placement of datapath functions in the datapath core. This wasted area increases the overall size of the chip.

Another problem with conventional placement systems is that they typically may take many hours to complete the placement of the circuit. This time delay, and the tact that conventional placement systems have no ability to determine the placement of datapath regions at the region level, means that the placement process is not interactive. Rather, the designer starts the placement process, and then reviews the results at a much later time. During placement and routing, the router will attempt to route the layout, and will only inform the designer at the end of the process as to whether the routing was possible. If the circuit cannot be routed, the process must be repeated after the designer makes changes in the circuit design. Accordingly, it would be desirable to have a placement and routing system that is interactive, allowing the designer to interactively specify the placement of datapath regions, with the placement and routing system indicating whether the circuit may be routed with the specified placement.

### SUMMARY

According to an exemplary embodiment, a method, system, and computer program product are provided for mapping a logical design including multiple logic blocks onto an integrated circuit chip. A chip level floor plan is created on the chip, including temporary areas on the chip set aside for accommodating logical blocks having logical content including timing requirements based on the logical design. The temporary areas are translated into physical cells on the chip with pins assigned for inputs and outputs for the logical blocks. The logical blocks are mapped to the physical cells on the chip in a time sensitive manner using timing assertions to form temporary logical partitions, the timing assertions including the timing requirements of the logical blocks. Blocks on the chip, including the temporary logical partitions, are connected based on the timing assertions. A timing analysis is performed on the chip to determine timing slack associated with each temporary logical partition. A determination is made whether the timing slack associated with each temporary logical partition is acceptable, if the timing slack associated with each temporary logical partition is not acceptable, the slack the temporary logical partitions is apportioned for, and apportioned slack information is fed hack in the form of timing assertions for use in mapping the logical blocks to the physical cells. Mapping, connecting, performing a timing analysis, and apportioning for slack are repeated until the timing slack associated with each temporary logical partition is determined to be acceptable.

### BRIEF DESCRIPTION OF THE DRAWINGS

Referring to the exemplary drawings, wherein like elements are numbered alike in the several Figures:

FIG. 1 illustrates a method for mapping a logical design to an integrated circuit according to an exemplary embodiment.

FIG. 2 illustrates a system for mapping a logical design to an integrated circuit according to an exemplary embodiment.

### DETAILED DESCRIPTION

Synthesis is typically used during the early stages of mapping a logic design to a technology implementation. For most designs, it is necessary, for run time reasons, to break up the design into a plurality of logic chunks or blocks (commonly referred to as “s-groups”). Each s-group has unique timing requirements specified in timing “assertion” files. On a large flat design, synthesis may not contain any physical placement mapping. What's more, the flattening process blurs the boundaries between s-groups. Because the flattening process typically takes places before a design is placed, feeding time information back to the s-group assertion files is nearly impossible. The flattening process and optimization tools can completely remove/replace nets and blocks that define the s-group boundaries and thereby invalidate the s-group assertion files at the physical design level.

Also, there are frequently paths between s-groups that make if is unclear what portion of the cycle time belongs to which, s-group in order to optimize the timing assertions. The “SlckStool process” which determines this is commonly called slack-apportionment. For this reason, the synthesis/slack-apportionment loop traditionally takes place before flattening and physical placement. While this works to a degree, it produces a less than optimal design, since placement information can greatly affect how slack should be apportioned.

So, given this type of design an environment, the problem is how to feed physical information back into the s-group assertion files without creating new tools.

According to an exemplary embodiment, the solution lies in the way the chip hierarchy is defined, perpetuated, and then dissolved, and also in how timing information is extracted and used. S-groups, which may be defined based on sensible logic partition and synthesis run-time limitations, are each mapped 1 to; onto a unique temporary physical partition or block having logical content. This partition may be referred to as an “sg-RLM” (s-group Relocatable Logical Macro). In traditional synthesis/slack apportionment process loops, no physical placement/routing detail is used. According to exemplary embodiments, synthesized s-groups are each mapped onto unique temporary physical partitions or sg-RLMs before slack apportionment, thus expanding the chip design process loop to include physical information. This physical information makes the slack apportionment process far more accurate compared to conventional techniques. In addition, as the sg-RLMs are temporary to physical layout at the chip level, a physical chip layout team can sample the output at any time, including when the process is complete. The output of the synthesis/slack apportionment loop is the input to the physical layout (physical design or PD). The chip level PD process may use optimization further down-stream (with decreased complexity) by flattening some or all of the sg-RLMs.

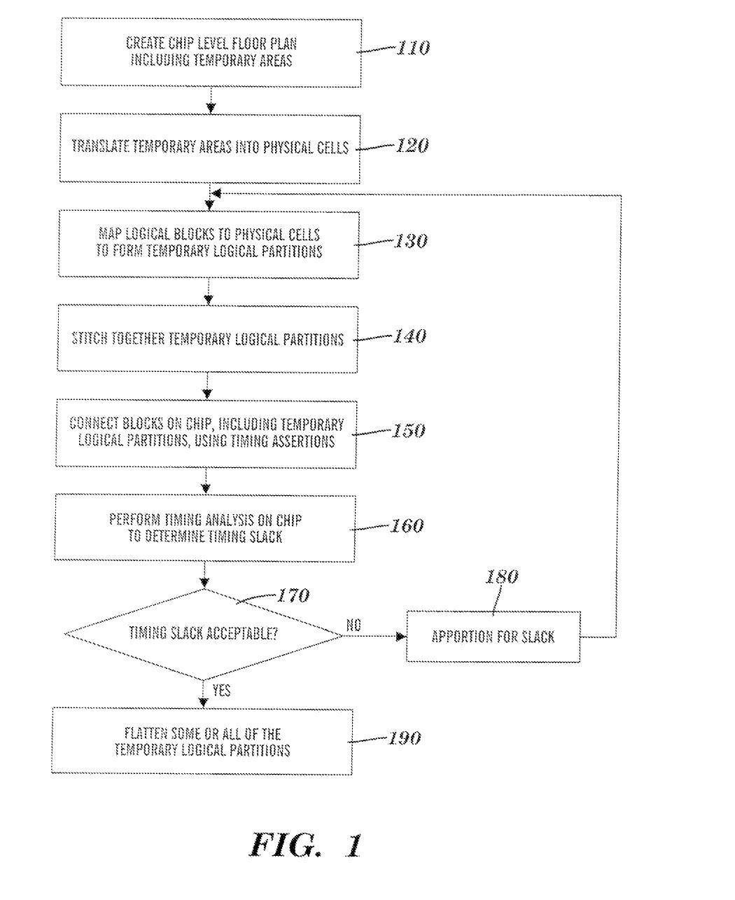

FIG. 1 illustrates an exemplary method for mapping a logical design onto an Integrated circuit chip according to an exemplary embodiment. At step 110, a chip level floor plan is created for mapping the logical design. The chip level floor plan may be created using guesses (and perhaps initial, synthesized (non-physical) models) as to how much area, what shape and what location would work for a given, partition, e.g., an sg-RLM. These areas may be referred to as “MCareas”. These “MCareas” serve as temporary spaces or boundary boxes on the chip set aside for particular logical functions. At this stage, a differentiation is emerging from the standard hierarchical physical design with the increased granularity of the physical partitions that are now at the s-group level.

These MCareas are then translated at step 120 into physical, cells (PHYSCELLS) with pins assigned for the sg-RLM inputs and outputs. The sg-RLMs are then mapped onto their associated PHYSCELLS by a macro PD tool at step 130 to form unique temporary partitions on the chip having logical content. This mapping includes optimizing timing at the RLM level such that the logical content is placed onto the chip in a time-sensitive manner. This optimization uses a feedback loop such that the shapes, areas, pins, and timing assertions for the sg-RLMs mapped to the physical cells are optimized through some number of iterations. At this point, the sg-RLMs have been synthesized and placed into blocks on the chip in a time sensitive way as “datapath cores”. The sg-RLMs are stitched together (but not flattened) at step 140 such that the logical connections and the physical connections are synthesized. At step 150, a chip PD tool uses the mapped sg-RLM and top-level connections, along with timing assertions, to connect all the sg-RLM blocks. Other blocks on the chip may also be connected at this time. Also at this stage, RLM-to-RLM overloaded, nets are corrected. That is, corrections are made to ensure that there is enough drive strength so that sg-RLM outputs are received at receiving sg-RLMs. This is important in order to get reliable timing calculations. These corrections may be made by, for example, adding repowering buffers into the design. At step 160, the chip is timed to determine timing slack associated with each sg-RLM (including timing slack occurring within each sg-RLM ad timing slack occurring between the sg-RLMs). That is, a timing analysis is performed on the chip to determine those sg-RLMs that have positive timing slack and those that have negative timing slack. At step 170, a determination is made whether the timing slack is acceptable. If not, the slack is apportioned for each sg-RLM at step 180. Thus, for those sg-RLMS that have positive timing slack, timing assertion are adjusted to allow less time. For those sg-RLMs that have negative timing slack, timing assertions are adjusted to allow more time. The apportioned slack information, is fed back in the form of sg-RLM timing assertions to step 130. The timing assertions are used in step 130 by the macro PD tool for RLM synthesis/physical optimization. Steps 130-180 are repeated until timing slacks are determined to be acceptable. At that point some or all of the sg-RLMs may be flattened at step 190 to allow greater efficiency for full chip wire routing.

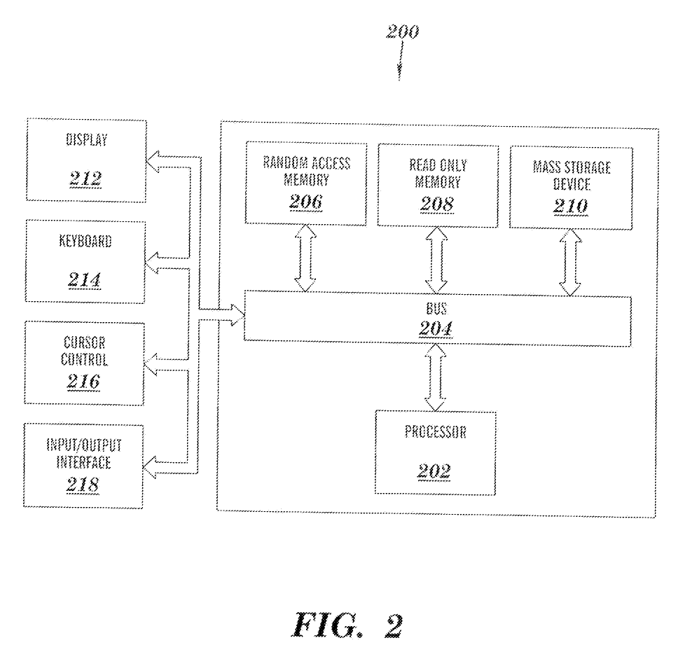

FIG. 2 illustrates a system for mapping a logical design onto an integrated circuit according to an exemplary embodiment. The system 200 may be used to perform logic syntheses of a design that is described in code. The system includes a processor 202 that is coupled through a bus 204 to memory. The memory may include, for example, random access memory 200, read-only memory 208, and a mass storage device 210. The mass storage device 210 represents a persistent data storage device, such as a floppy-disk drive, a fixed disk drive (e.g., an optical drive, a magnetic drive, or the like). The processor 202 may be embodied in a general-purpose processor, such as the Intel Pentium® processor, a special purpose processor, or a specially programmed logic device. The system may also include a display 212 coupled to the processor 202 through the bus 204 to provide a graphical output for the computer system. This graphical output may be a graphical user interface that may be used to control the operation of the system by a user via, e.g., a keyboard 214 and cursor coupled 216 to the bus 204 for providing information and command selections to the processor. An input/output Interlace 218 may also be connected to the processor to control and transfer data to and from peripherals, such as printers and other computers connected to the system, via wireless and wireline connections and networks such as a computer network, a telephone network, a broadband network, etc.

The processor 202 performs mapping of logical designs as described above. The process for mapping logical designs may be embodied as a program within memory or on a signal bearing medium, and executed by the processor.

As described above, embodiments can be embodied in the form of computer-implemented processes and apparatuses for practicing those processes, ha exemplary embodiments, the invention is embodied in computer program code executed by one or more network elements. Embodiments include computer program code containing instructions embodied in tangible media, such as floppy diskettes. CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments may configure the microprocessor to create specific logic circuits.

According to exemplary embodiments, a technique is provided for mapping a logical design onto an integrated circuit in such a manner that slack is apportioned for. According to exemplary embodiments, a technique is provided for automatic placement and routing of logical designs on an integrated circuit, utilizing and preserving the regularity of datapath sections. The designer is allowed to define datapath regions including datapath functions in the circuit and provide this information to a placement system for determining the placement of logic cells in the datapath functions, while preserving the regularity of the datapath. High performance integrated circuits may be placed and routed automatically instead of manually or with custom library cells. As a beneficial result, desirable circuit performance results approaching custom design are achievable with the time to market benefits of automated design systems.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scone thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for mapping a logical design including multiple logical blocks onto an integrated circuit chip, comprising:
creating a chip level floor plan including temporary areas on the chip set aside for accommodating logical blocks having logical content including timing requirements based on the logical design;
translating the temporary areas into physical cells on the chip with pins assigned for inputs and outputs for the logical blocks;
mapping the logical blocks to the physical cells on the chip in a time sensitive manner using timing assertions to form temporary logical partitions, wherein the timing assertions include the timing requirements of the logical blocks;
connecting blocks on the chip, including the temporary logical partitions, based on the timing assertions;
performing a timing analysis on the chip to determine timing slack associated with each temporary logical partition;
determining whether the timing slack associated with each temporary logical partition is acceptable; and
if the timing slack associated with each temporary logical partition is not acceptable, apportioning for the slack in the temporary logical partitions and feeding back apportioned slack information in the form of timing assertions for use in mapping the logical blocks to the physical cells, wherein the steps of mapping, connecting, performing a timing analysis, and apportioning for slack are repeated until the timing slack associated with each temporary logical partition is determined to be acceptable.

2. The method of claim 1, wherein the step of creating the chin level floor plan includes estimating sizes, shapes, and locations of the temporary areas for accommodating the logical blocks.

3. The method of claim 1, wherein the step of mapping includes iteratively optimizing the sizes, shapes, and locations of the temporary logical partitions and the assignment of input and output pins on the chip using the timing assertions.

4. The method of claim 1, further comprising stitching together the temporary logical partitions before connecting the blocks on the chip.

5. The method of claim 1, further comprising flattening some or all the temporary logical partitions.

6. The method of claim 5, wherein the step of flattening is performed after determining that the slack for each temporary logical partition is acceptable.

7. The method of claim 6, wherein the step of flattening forms a permanent logical design on the chip.

8. A system for mapping a logical design including multiple logical blocks onto an integrated circuit chip, comprising:
an input for receiving the logical design;
a processor for creating a chip level floor plan including temporary areas on the chip set aside for accommodating logical blocks having logical content including timing requirements based on the logical design, translating the temporary areas into physical cells on the chip with pins assigned for inputs and outputs for the logical blocks, mapping the logical blocks to the physical cells on the chip in a time sensitive manner using timing assertions to form temporary logical partitions, wherein the timing assertions include the timing requirements of the logical blocks, connecting blocks on the chip, including the temporary logical, partitions, based on the timing assertions, performing a timing analysis on the chip to determine timing slack associated with each temporary logical partition, determining whether the timing slack associated with each, temporary logical partition is acceptable, and, if the timing slack associated with each temporary logical partition is not acceptable, apportioning for the slack in the temporary logical partitions and feeding back apportioned slack information in the form of timing assertions for use in mapping the logical blocks to the physical cells, wherein the processor repeats the mapping, connecting, timing analysis, and apportioning for slack until the timing slack associated with each temporary logical partition is determined to be acceptable.

9. The system of claim 8, wherein as part of creating the chip level floor plan, the processor estimates sizes, shapes, and locations of the temporary areas for accommodating the logical blocks.

10. The system of claim 8, wherein as part of mapping, the processor iteratively optimizes sizes, shapes, and locations of the temporary logical partitions and the assignment of input and output pins on the chip using the timing assertions.

11. The system of claim 8, wherein the processor stitches together the temporary logical partitions before connecting the blocks on the chip.

12. The system of claim 8, wherein the processor flattens some or all the temporary logical partitions.

13. The system of claim 12, wherein the processor flattens temporary logical partitions after determining that the slack for each temporary logical partition is acceptable to form a permanent logical design on the chip.

14. A computer program product for mapping a logical design including multiple logical blocks onto an integrated circuit chip, comprising a computer usable medium having a computer readable program, wherein the computer readable program, when executed on a computer, causes the computer to perform steps including:
creating a chip level floor plan including temporary areas on the chip set aside for accommodating logical blocks having logical content including timing requirements based on the logical design;
translating the temporary areas into physical cells on the chip with pins assigned for inputs and outputs for the logical blocks;
mapping the logical blocks to the physical cells on the chip in a time sensitive manner using timing assertions to form temporary logical partitions, wherein the timing assertions include the timing requirements of the logical blocks;
connecting blocks on the chip, including the temporary logical partitions, based on the timing assertions;
performing a timing analysis on the chip to determine timing slack associated with each temporary logical partition;
determining whether the timing slack associated with each temporary logical partition is acceptable; and
if the timing slack associated with each temporary logical partition is not acceptable, apportioning for the slack in the temporary logical partitions and feeding back apportioned slack information in the form of timing assertions for use in mapping the logical blocks to the physical cells, wherein the steps of mapping, connecting, performing a timing analysis, and apportioning for slack are repeated until the tuning slack associated with each temporary logical partition is determined to be acceptable.

15. The computer program product of claim 14, wherein the step of creating the chip level floor plan includes estimating sizes, shapes, and locations of the temporary areas for accommodating the logical blocks.

16. The computer program product of claim 14, wherein the step of mapping includes iteratively optimizing the sizes, shapes, and locations of the temporary logical partitions and the assignment of input and output pins on the chip using dm timing assertions.

17. The computer program product of claim 14, wherein the computer readable program further causes the computer to stitch together the temporary logical partitions before connecting the blocks on the chip.

18. The computer program product of claim 14, wherein the computer readable program further causes the computer to flatten some or all the temporary logical partitions.

19. The computer program product of claim 18, wherein flattening is performed after determining that the slack for each temporary logical partition is acceptable.

20. The computer program product of claim 196, wherein the flattening forms a permanent logical design on the chip.
